(19) United States
(12) Patent Application Publication
(10) Pub. No.: US 2009/0183432 A1
(43) Pub. Date: Jul. 23, 2009

(54) HOOK AND LOOP WEATHERSTRIPPING SYSTEM

(76) Inventor: Dave B. Lundahl, Fort Collins, CO (US)

Correspondence Address: COCHRAN FREUND & YOUNG LLC, 2026 CARIBOU DR, SUITE 201, FORT COLLINS, CO, 80525, US

(21) Appl. No.: 12/414,579

(22) Filed: Mar. 30, 2009

Related U.S. Application Data
(63) Continuation of application No. 11/209,248, filed on Aug. 22, 2005.
(60) Provisional application No. 60/665,148, filed on Mar. 24, 2005.

(51) Int. Cl. E06B 7/16; E06B 7/00; E06B 3/00

(52) U.S. Cl. 49/70; 49/493.1; 49/506

(57) ABSTRACT

Disclosed is a two part hook and loop weatherstripping system in which one portion, such as the hook portion that is attached to a window frame and another portion such as the loop portion that is attached to the hook portion and includes a flexible material that may be compressible to provide a seal between a window sash and the window frame. The removable portion can be easily removed and cleaned or replaced with a new portion. Different thicknesses of the removable portion of the hook and loop weatherstripping allows various size gaps between a window frame and a sash to be easily filled. The use of two part hook and loop components incorporating a weatherstripping system provides for the components to be utilized in such a way so as to provide an overlap joint at all corners that restricts linear shrinkage and eliminates the holes that commonly materialize at the corners from shrinkage of single part weatherstripping systems. The compressible portion of the weatherstripping can be easily removed using the hook and loop fastener and replaced to provide a weathertight seal. A window screen can also be incorporated in the weatherstripping system to allow easy removal of the window screen for replacement or cleaning.

### CROSS REFERENCE TO RELATED APPLICATIONS

This application is a continuation of U.S. patent application Ser. No. 11/209,248, entitled “Hook and Loop Weatherstripping System,” filed Aug. 22, 2005, by Dave B. Lundahl, which application claims benefit of and priority to U.S. Provisional Patent Application Ser. No. 60/665,148, entitled “Hook and Loop Weatherstripping System,” filed Mar. 24, 2005, by Dave B. Lundahl, the entire contents of which are specifically incorporated herein by reference for all that it disclose and teach.

### BACKGROUND OF THE INVENTION

The present invention pertains generally to weatherstripping and more particularly to removable weatherstripping for doors and windows.

Weatherstripping plays a valuable function in sealing doors and windows from leakage of air through the cracks or openings that exist between window frames and window casings as well as door frames and door casings. Weatherstripping functions to fill the gaps that exist between window frames and window sashes, thereby stopping the flow of air in these potential openings. Spring metal has been used as a material to fill the gap and function as a weather strip. Subsequent improvements included outwardly projecting piles similar to a continuous narrow brush that were used to fill the gaps between a window sash and a window frame. Further improvements included rows of rubber, foam and other materials. Since these gaps vary in depth, different thicknesses of the weatherstripping must be used even for doors and windows of the same make and model as a result of variations during the manufacturing process. In addition, windows and doors may warp over time so that weatherstripping that once filled the gap between a door or window sash and its associated frame, no longer fills that gap. Leakage occurs when the weatherstripping that originally provided an adequate seal, no longer bridges the wider gap that may later exist from a warped window sash or door. In windows, warpage of the sash and other reasons for improper sealing of the sash to the frame result from moisture, heat, sag or deterioration of a hinge or hinge anchorage. Compression and fatigue of the weatherstripping can also cause gaps. These problems, over time, can create a gap that is significantly greater than the gap at the time of manufacture and can render the original weatherstripping thickness inadequate to bridge the new gap created by these problems.

Further, the commonly used pile weatherstripping tends to collect dirt and dust and can be very difficult to clean. Further, the modern flexible weatherstripping tends to shrink in length when subjected to temperatures that are colder than the indoor temperatures that typically exist when the weatherstripping is originally applied to a new window during window assembly. This cold weather shrinkage can produce significant gaps at the corners of the window as the weatherstripping pulls back from the corners since vertical weatherstripping components are butt or miter joined to horizontal weatherstripping components and can pull apart.

### SUMMARY OF THE INVENTION

The present invention overcomes the disadvantages and limitations of the prior art by providing a two-part weatherstripping that becomes functional through a hook and loop fastener system.

The present invention may therefore comprise: a hook and loop weatherstripping combination comprising a hook portion having a rigid backing with a front surface, a back surface opposite to the front surface, a plurality of semi-rigid hooked strands in a dense relationship upstanding from the front surface with hook ends of the strands extending away from the front surface, the hook strands secured to the backing along the face of the front surface, the hook portion attached to a window frame; a loop portion having a flexible, fibrous backing with a front surface, a back surface opposite to the front surface, a plurality of flexible fiber loops in a dense relationship upstanding from the front surface with the loops extending away from the front surface and secured to the flexible fibrous backing; and the loop portion being engaged with the hook portion of the weatherstripping combination to form a compressible, flexible barrier to the passage of air between a window sash and a window frame.

The present invention may further comprise a method of creating a barrier between a window sash and a window frame using weatherstripping comprising: attaching a hook portion of the weatherstripping to the window frame, the hook portion having a rigid backing with a back surface that is attached to the window frame, a front surface of the rigid backing that has a plurality of hook strands upstanding from the front surface having hook ends, the hook strands attached to the front surface of the rigid backing; and engaging a loop portion of the weatherstripping to the hook portion, the loop portion having a flexible backing with a front surface having a plurality of fiber loops upstanding from the front surface with loops that are capable of engaging the hook ends of the plurality of hook strands, and a back surface that is formed of a compressible material so that a compressible flexible barrier is formed between the window sash and the window frame.

The advantages of various embodiments include the ability to easily remove one portion of the weatherstripping and clean or replace it with new weatherstripping. In addition, as the gap may change between a window sash and window frame, different thicknesses of the weatherstripping can be easily applied to provide a new and effective seal by filling the gap between the window sash and window frame. In addition, the two part weatherstripping can be applied in such a way that the second, top portion, always overlaps the ends of the first portion that is attached to the frame and thereby eliminate the shrinkage induced open corner gaps that are common to single component weatherstripping systems.

### BRIEF DESCRIPTION OF THE DRAWINGS

FIG. 1 is a side sectional view through a typical bottom horizontal window frame illustrating implementation of one embodiment of a hook and loop weatherstripping system.

FIG. 1A is a side sectional view illustrating another implementation of an embodiment of a hook and loop weatherstripping system.

FIG. 2 is a upper right hand corner frontal view of a typical window frame illustrating the horizontal head frame joined to the vertical jamb frame and implementation of another embodiment of a hook and loop weatherstripping system.

FIG. 3 is a side sectional view through a typical bottom horizontal window frame showing an implementation of another embodiment of a hook and loop weatherstripping system.

FIG. 4 is a side sectional view through a typical bottom horizontal window frame showing an implementation of another embodiment of a hook and loop weatherstripping system.

FIG. 5 is a side sectional view through a typical bottom horizontal window frame illustrating an implementation of another embodiment of a hook and loop weatherstripping system.

FIG. 6 is a side sectional view through a typical bottom horizontal window frame illustrating an implementation of another embodiment of a hook and loop weatherstripping and screen system.

FIG. 7 is a side sectional view through a typical bottom horizontal window frame incorporating a hook and loop weatherstripping and screen system.

### DETAILED DESCRIPTION OF THE INVENTION

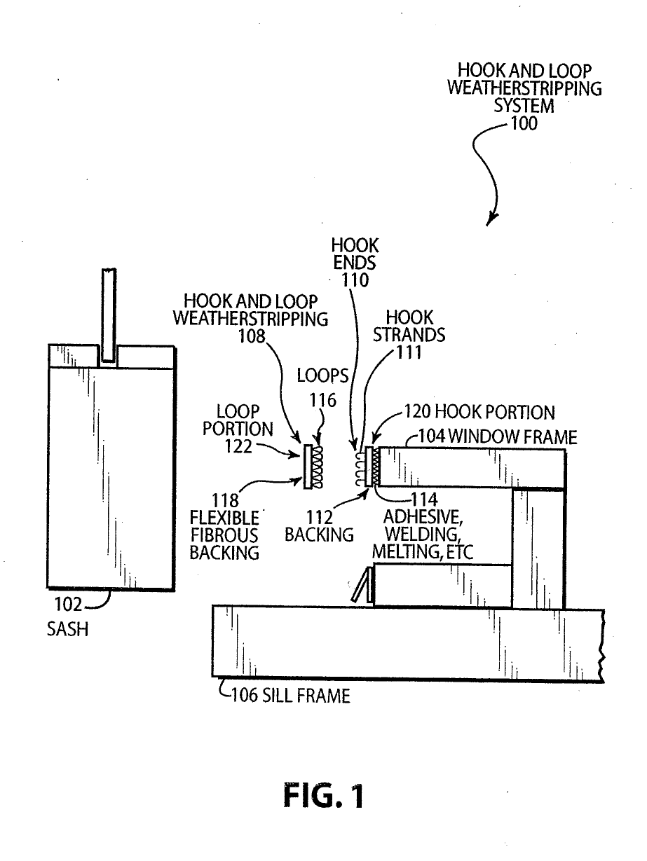

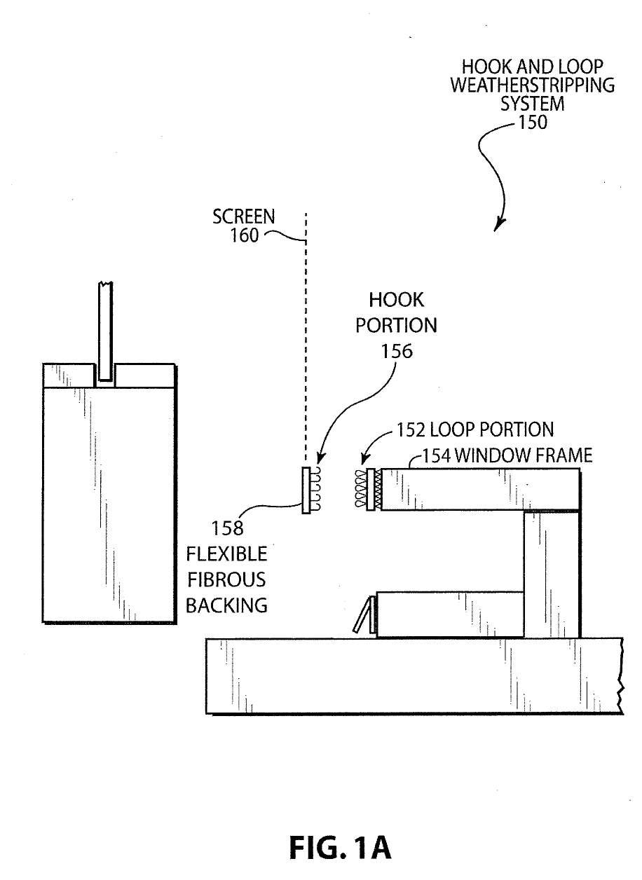

FIG. 1 is a side horizontal section view of a window system illustrating an embodiment of a hook and loop weatherstripping system 100. As shown in FIG. 1, a window sash 102 is in a partially open position with respect to window frame 104. Window frame 104 is coupled to the sill frame 106. The illustration of FIG. 1 is a side horizontal section view of each of the portions of a standard window, such as a standard casement type window sill. The hook and loop weatherstripping system 108 is also shown in FIG. 1. The hook and loop weatherstripping 108 includes a hook portion 120 and a loop portion 122. The hook portion 120 has hook ends 110 that extend from the hook strands 111 that are attached to a backing material, such as a stiff backing 112. The stiff backing 112 is attached to the window frame 104 by one or more various techniques such as stapling, gluing using an adhesive, welding the backing 112 to the window frame 104, melting of the backing and/or the window frame 104, etc. Welding or melting can be done through the use of heat, ultrasonic sound waves, chemicals or other known techniques. The loop portion 122 has a series of loops 116 that interact with and engage the hook ends 110 so that the loop portion 122 and hook portion 120 can become securely engaged with one another. The loops 116 are attached to a flexible fibrous backing 118 that engages the sash 102 when the sash 102 is closed to a tightened position against the hook and loop weatherstripping 108. The pressure of the sash 102 against the hook and loop weatherstripping 108 provides a seal between the sash and the window frame that seals the flow of air from the interior portion of the window to the outside and vice versa.

The flexible fibrous backing 118 can be made of a compressible material to ensure a tight seal all the way around the window frame 104 and the sash 102. The flexible fibrous backing 118 can also be made of different thicknesses to ensure that a tight seal is provided between the sash 102 and window frame 104. For example, variations in the gap that may exist between the window frame 104 and sash 102 as a result of imperfections in the manufacturing processes can be filled by different thicknesses of the flexible fibrous backing 118 to ensure that such a gap is filled.

As explained above, this gap can also occur due to usage and other problems of window placed in service. In that regard, a clear advantage of the hook and loop weatherstripping 108 of the present invention is that the loop portion 122 can be easily removed from the hook portion 120. The loop portion can be cleaned or replaced with a new loop portion 122 which is clean and has an aesthetic appearance. In addition, the loop portion 122 can have a flexible fibrous backing 118 of a different thickness if the gap between the sash 102 and window frame 104 has changed or if, for any reason, the hook and loop weatherstripping 108 did not entirely fill the gap between the sash 102 and window frame 104. In addition, if the flexible fibrous backing 118 becomes aged and is no longer compressible, or does not fit properly on the hook portion 120, the loop portion 122 can also be replaced with a new section without the necessity of replacing the entire hook and loop weatherstripping 108 which may be difficult, time consuming and expensive. This is explained in more detail below. In addition, the loop portion 122 can be manually cleaned by putting the loop portion 122 in a washing machine. The loop portion 122 can then be engaged with the hook portion 120 in a simple and easy fashion. Pressure applied by the sash 102 to the loop portion 122 also helps to engage the hooks 110 with the loops 116 when the loop portion 122 is replaced on the hook portion 120. This pressure applied by the sash 102 assists in ensuring that the loop portion 122 and hook portion 120 are securely engaged.

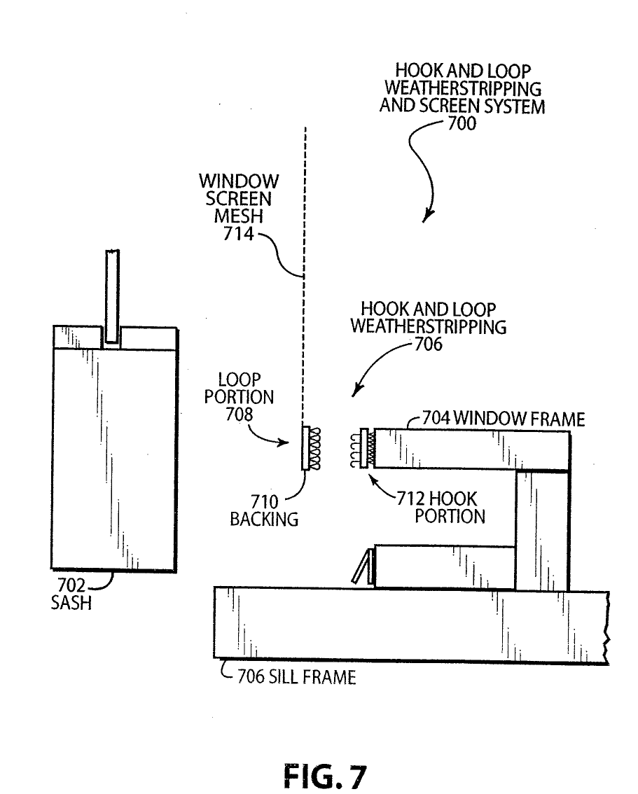

FIG. 1A is a side sectional view of a hook and loop weather stripping system 150 that is similar to the embodiment of FIG. 1. As shown in FIG. 1A, the loop portion 152 is connected to the window frame 154. The hook portion 156 is connected to the flexible fibrous backing 158. Additionally, screen 160 may be connected to the flexible fibrous backing, as illustrated in FIGS. 7 and 8.

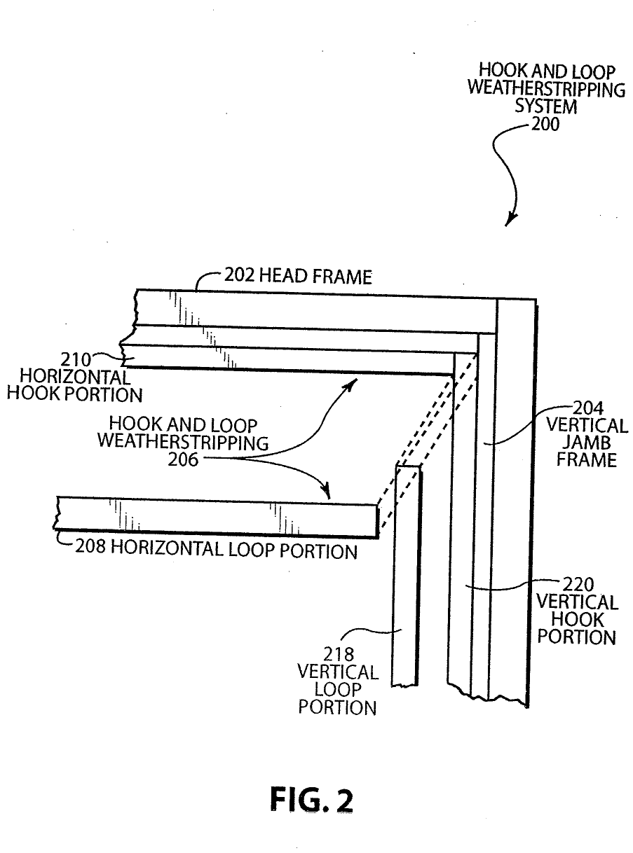

FIG. 2 illustrates another embodiment of the two part hook and loop weatherstripping system 200. As shown in FIG. 2, the upper right hand corner of a typical window frame is shown with its horizontal head frame 202 joined to its vertical jamb frame 204 at a normal right angle. The hook and loop weatherstripping 206 includes the horizontal loop portion 208 and the horizontal hook portion 210. The hook and loop weatherstripping 206 is repeated in the vertical with the loop portion 218 and the hook portion 220. The vertical components of the hook portion 220 have been cut at a length that is as long as possible to fit in the area of the frame 204 that is to be weatherstripped and secured to the window frame 204 by a variety of methods. The horizontal components of the hook portion 210 have been cut at a length so that its ends butt tightly to the vertical component 220 and is secured to the 202 head frame. In contrast to the relationship of the hook portion 210 butting to the vertical hook portion 220, the horizontal component of the loop portion 208 has been cut at a length that is as long as possible to fit in the area of the frame 204 that is to be weatherstripped and when engaged with the hook portion of the weatherstripping engages both the horizontal hook component 210 as well as the end of the vertical hook component 220. This embodiment of the two part hook and loop weatherstripping system 200 is repeated at all corners of the frame and effectively locks the vertical and horizontal elements of the weatherstripping together thus eliminating the holes in a window weatherstripping system that typically occur due to shrinkage of the single part component systems.

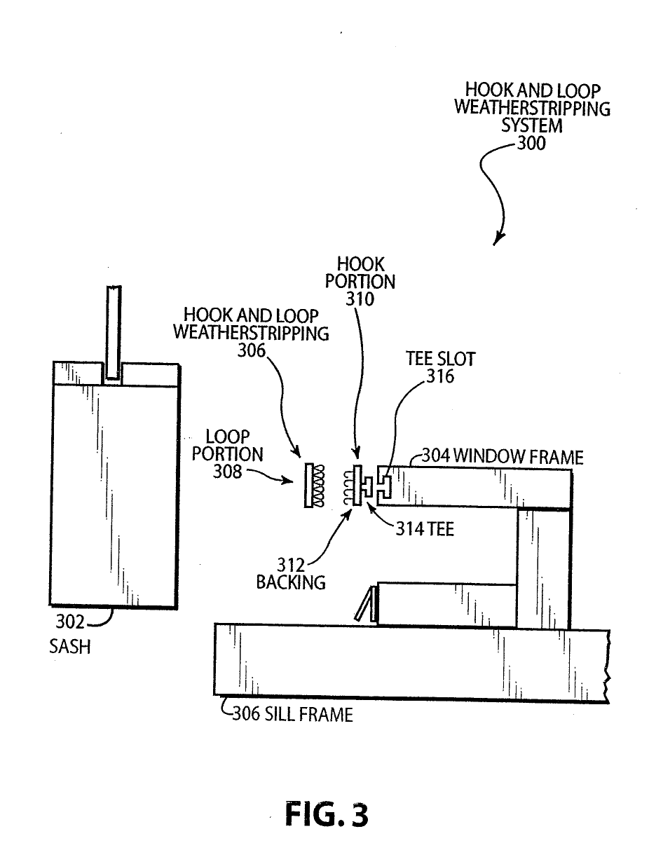

FIG. 3 illustrates another embodiment of the hook and loop weatherstripping system 300. As shown in FIG. 3, the sash 302 is shown in an open position from the window frame 304. The hook and loop weatherstripping 306 includes the loop portion 308 and the hook portion 310. The hook portion has a stiff backing 312 that has a tee portion 314 which is attached to, or forms part of, the backing 312. The tee portion 314 engages a tee slot 316 in the window frame 304 to securely attach the hook portion 310 to the window frame 304. The embodiment 300 illustrates the manner in which the hook portion 310 can be securely engaged to the window frame 304 so that the hook portion 310 can be semi-permanently attached to the window frame 304. Again, the loop portion 308 can be easily removed from the hook portion 310 so that it can be replaced or cleaned. Of course, the loop portion and hook portion can be used interchangeably with one another.

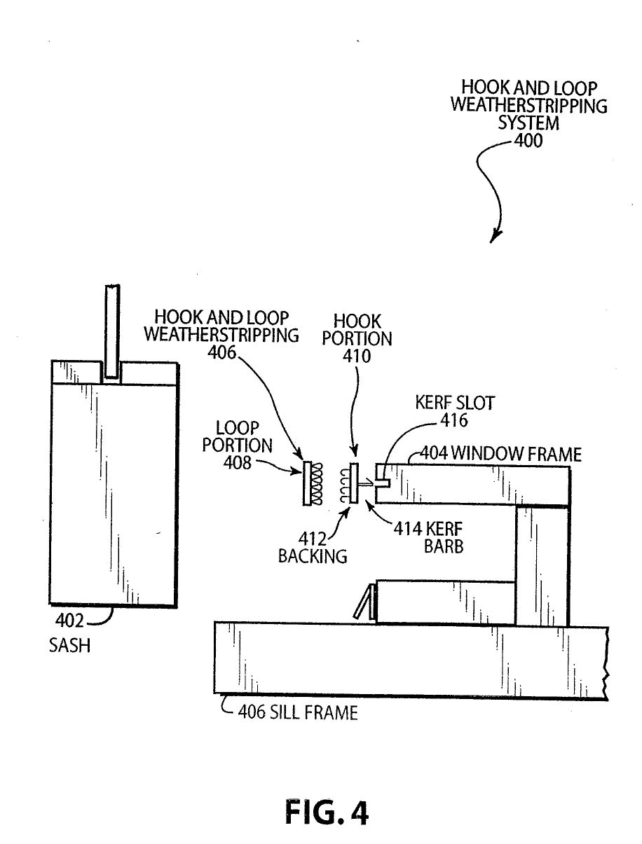

FIG. 4 illustrates another embodiment of a hook and loop weatherstripping system 400. As shown in FIG. 4, sash 402 is shown in a partially open position with respect to the window frame 404. The hook and loop weatherstripping 406 has a loop portion 408 and a hook portion 410. The hook portion 410 has a semi-stiff backing 412 that includes a kerf barb 414. The kerf barb 414 can be attached to or form a part of the backing 412. The kerf barb is adapted to be inserted in a kerf slot 416 formed in the window frame 404. When the kerf barb 414 is inserted in the kerf slot 416, the hook portion 410 becomes securely attached to the window frame 404.

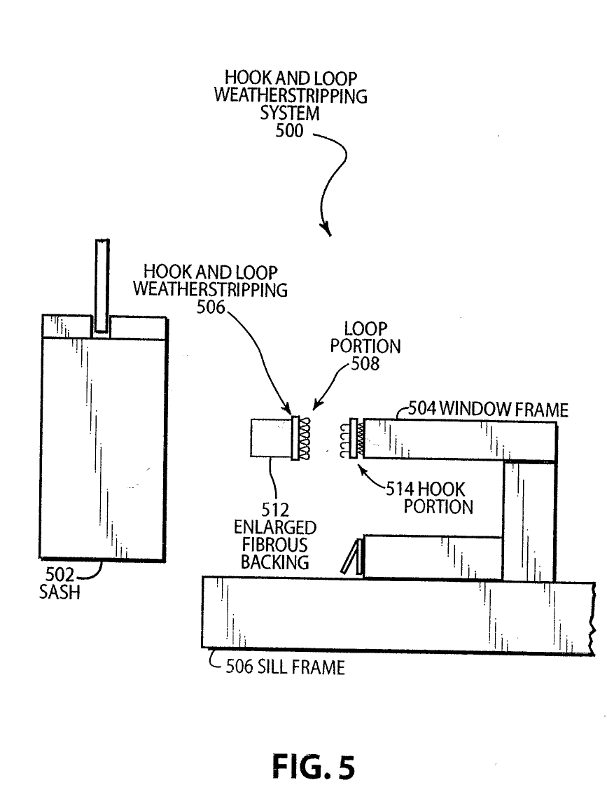

FIG. 5 illustrates another embodiment of a hook and loop weatherstripping system 500. As shown in FIG. 5, sash 502 is shown in a partially open position with respect to the window frame 504. The hook and loop weatherstripping 506 includes a loop portion 508 and a hook portion 514. The loop portion 508 includes an enlarged fibrous backing 512 that provides a greater thickness of the weatherstripping. The thickness of the large fibrous backing 512, which is shown in the horizontal direction on FIG. 5, can be any desired amount to fill a gap that may exist between the sash 502 and window frame 504. The enlarged fibrous backing 512 can be made of a compressible material to ensure sealing between the sash 502 and window frame 504. The enlarged fibrous backing 512 can form part of the backing of the loop portion 508 or can be a separate portion that is adhered to the backing of the loop portion 508 by any desired method such as gluing, melting, welding, bolting, screwing, etc. as described herein. As indicated above, the enlarged fibrous backing 512 can be constructed as a single piece of various thicknesses so that various size gaps can be filled. The hook portion 514 can be attached to the window frame 504 in any desired manner, such as disclosed above. Again, the loop portion 508 can be easily removed from the hook portion 514 for cleaning, replacement or new sizing as a result of the change in the gap between the sash 502 and window frame 504.

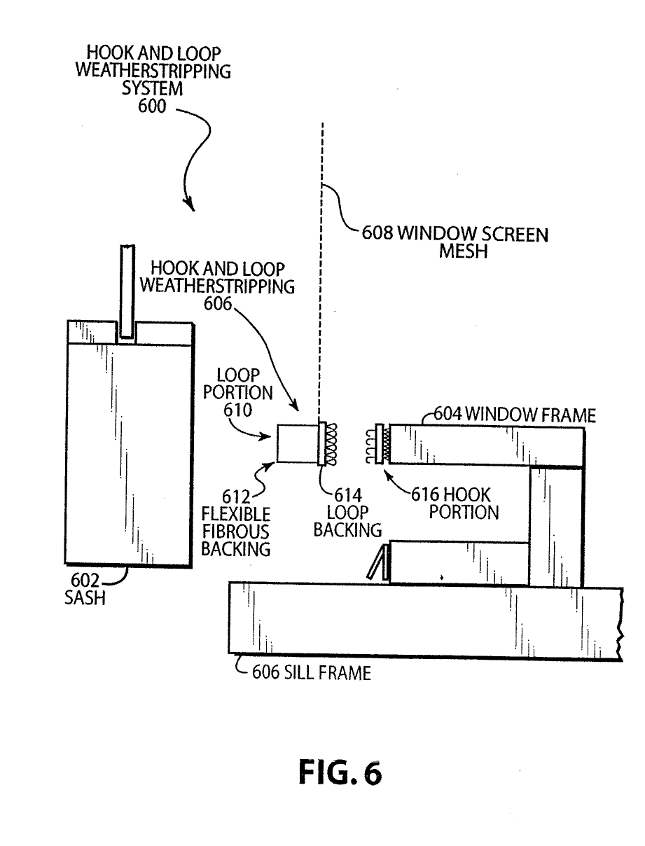

FIG. 6 is a schematic side view of another embodiment of a hook and loop weather stripping and screen system. As shown in FIG. 6, sash 602 is shown in a partially open position with respect to the window frame 604. The hook and loop weatherstripping 606 has a loop portion 610 and hook portion 616. The loop portion 610 has a flexible fibrous backing 612 and a backing 614 for the loop structure. Disposed and attached to the loop portion 610 is a window screen 608 that is disposed between the flexible fibrous backing 612 and the loop backing 614. The window screen 608 can be attached in the loop portion 610 by any desired method including stitching, gluing, melting or welding (through the use of heat, ultrasonics, chemicals, etc.) to the flexible fibrous backing 612 and the loop backing 614. As shown in FIG. 6, the loop portion 610 can therefore hold the window screen 608 in a stationary position with respect to the window frame 604 when attached to the hook portion 616 as well as providing a weatherstrip. Again, any desired thickness of the weatherstripping 606 can be provided to fill the gap between the window frame 604 and the sash 602. Window screen 608 can be sized to fit tightly, without sagging in the window, when the loop portion 610 is attached to the hook portion 616. A small degree of adjustment is provided in the weatherstripping and screen system 600 illustrated in FIG. 6 by providing a small amount of adjustment of the position of the loop portion 610 with the hook portion 616 to prevent any sagging of the window screen 608. Again, hook portion 616 can be at least semi-permanently attached to the window frame 604. Replacement of the loop portion 610 as well as the window screen 608 can be easily accomplished by simply removing the loop portion 610 from the hook portion 616 to allow cleaning or replacement. In this fashion, a great degree of flexibility is achieved so that the window screen 608 and the loop portion 610 can be replaced if damaged or if replacement is otherwise needed. In addition, when the window screen 608 is sized so that its' outer most dimensions match the dimensions of the outer most perimeter edge of the hook portion 616 of the hook and loop weatherstripping 606 when the hook portion 616 is installed on the window frame 604, then the screen also serves to provide guidance for the optimum positioning all of the perimeter elements of the loop 610 portion of the hook and loop weatherstripping 606.

FIG. 7 is a schematic side view of another embodiment of a hook and loop weatherstripping and screen system 700. As shown in FIG. 7, a sash 702 is in a partially open position with respect to the window frame 704. Hook and loop weatherstripping 706 is shown that has a loop portion 708 and a hook portion 712. The hook portion 712 is at least semi-permanently attached to the window frame 704 as disclosed above. The loop portion 708 includes a backing 710 to which a screen 714 is attached. The window screen 714 can be attached to the backing 710 in any desired manner including gluing, melting with heat, ultrasonics or chemical melting, welding, sewing or any other desired way of attaching window screen 714 to the backing 710. Many window screens 714 are made of a plastic-type material that can have a melting temperature that is similar to the melting temperature of backing 710 so that an effective weld, through melting, can be achieved to securely attach the window screen 714 to the backing 710. Again, the backing 710 can comprise a fibrous, flexible material that can also be a compressible material to ensure an adequate seal that fills the gap between the sash 702 and window frame 704. In addition, the backing 710 can be made of different thicknesses to provide sufficient material to fill the gap that exists between the sash 702 and window frame 704.

Hence, the disclosed embodiments provide a unique hook and loop weatherstripping system and a unique hook and loop weatherstripping and screen system that has many advantages. The loop portion can be removed for cleaning or replacement in a simple and easy fashion. If damage occurs to the loop portion or if damage occurs to a window screen, the loop portion can be removed and easily replaced. Removal of the loop portion or the loop and screen portion can allow for easy cleaning of both the screen and the weatherstripping. Different thicknesses of the flexible, fibrous backing of the loop portion can be provided to fill gaps that exist or may be generated over time as a result of use of the window system. In this manner, secure seals can be made in a simple and easy fashion by replacement of the loop portion 122 with a loop portion having a thicker, flexible, fibrous backing 118. In addition, substantial savings can be realized by replacing metal frame screens with the hook and loop weatherstripping and screen system.

Of course, the system has been shown with respect to an implementation with casement type windows, but can be used with doors or other access openings. Additionally, although the removable portion has been shown as a loop portion, the hook portion can be made removable and the loop portion attached to the frame, as desired.

The foregoing description of the invention has been presented for purposes of illustration and description. For example, the flexible fibrous backing of the loop portion can comprise any desired type of compressible material such as a compressed plastic, foam or other material. Attachment of either portion of the hook and loop devices to the window frame can be achieved in any desired manner including T-Slot or Kerf application, bolting, screwing or stapling, in addition to gluing, welding or melting. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A hook and loop weatherstripping combination comprising:
a hook portion having a hook portion backing with a hook portion front surface, a hook portion back surface, which is opposite to said hook portion front surface, a plurality of hook strands in a dense relationship upstanding from said hook portion front surface with hook ends of said hook strands extending away from said hook portion front surface, said hook strands secured to said hook portion backing along said hook portion front surface, said back surface of said hook portion attached to and substantially encompassing a window frame at a location on said window frame where a window sash engages said window frame;
a loop portion having a loop portion flexible, compressible loop backing with a loop backing front surface, a loop backing back surface, which is opposite to said loop backing front surface, a plurality of loops in a dense relationship upstanding from said loop backing front surface with said loops extending away from said loop backing front surface and secured to said flexible, compressible loop backing; and
said loop portion being engaged with said hook portion of said weatherstripping combination to form a compressible, flexible barrier to the passage of air between said window sash and said window frame.

2. The hook and loop weatherstripping combination of claim 1 wherein:
said hook portion is formed from individual strips attached to said window frame with ends of said strips disposed proximate to each other;
said loop portion engaging said hook portion such that said loop portion overlaps with said ends of said strips of said hook portion so that said hook portion and said loop portion are locked together, which substantially prevents gaps in said weatherstripping from forming as a result of shrinkage of said hook portion and said loop portion at low temperatures.

3. The hook and loop weatherstripping combination of claim 1 further comprising:
a screen attached to said loop portion.

4. A loop and hook weatherstripping combination comprising:
a loop portion having a loop portion backing with a loop portion front surface, a loop portion back surface, which is opposite to said loop portion front surface, a plurality of loops in a dense relationship upstanding from said loop portion front surface with said loops extending away from said loop portion front surface, said loops secured to said loop portion backing along said loop portion front surface, said back surface of said loop portion attached to and substantially encompassing a window frame at a location on said window frame where a window sash engages said window frame;
a hook portion having a flexible, compressible hook backing with a hook backing front surface, a hook backing back surface opposite to said hook backing front surface, a plurality of hooks in a dense relationship upstanding from said hook backing front surface with said hooks extending away from said hook backing front surface and secured to said hook backing front surface; and
said hook portion being engaged with said loop portion of said weatherstripping combination to form a compressible, flexible barrier to the passage of air between said window sash and said window frame.

5. The loop and hook weatherstripping combination of claim 4 wherein:
said loop portion is formed from individual strips attached to said window frame with ends of said strips disposed proximate to each other;
said hook portion engaging said loop portions such that said hook portions overlap with said ends of said strips of said loop portions so that said loop portions and said hook portions are locked together, which substantially prevents gaps in said weatherstripping from forming as a result of shrinkage of said loop portion and said hook portion at low temperatures.

6. The loop and hook weatherstripping combination of claim 4 further comprising:
a screen attached to said hook portion.

7. A hook and loop weatherstripping combination for a window comprising:
a first portion having a first backing with a first front surface, a first back surface opposite to said first front surface, a plurality of first connectors attached to said first front surface of said first portion, said first connectors secured to said first backing along said first front surface, said back surface of said first portion attached to and substantially surrounding a window frame at a location on said window frame where a window sash engages said window frame;
a second portion having a flexible, compressible second backing that forms a flexible and compressible seal that engages said window sash of said window when said window is in a closed position, said second portion having a second front surface, a second back surface, which is opposite to said second front surface, a plurality of second connectors arranged in a dense relationship upstanding from said second front surface of said second portion and secured to said flexible, compressible second backing; and
said second portion being engaged with said first portion of said weatherstripping combination, and not attached to said window sash, to form a compressible, flexible barrier that substantially surrounds said window frame and substantially prevents the passage of air between said window sash and said window frame.

8. The hook and loop weatherstripping combination of claim 7 wherein:
said first portion is formed from individual strips attached to said window frame with ends of said strips disposed proximate to each other;
said second portion is attached to said first portion such that said second portion overlaps with said ends of said individual strips of said first portion so that said first portion and said second portion are locked together, which substantially prevents gaps in said weatherstripping from forming as a result of shrinkage of said second portion and said first portion at low temperatures.

9. The hook and loop weatherstripping combination of claim 7 further comprising:
a screen attached to said second portion.

10. The hook and loop weatherstripping combination of claim 9 wherein said first portion is a loop portion and said second portion is a hook portion.

11. The hook and loop weatherstripping combination of claim 9 wherein said first portion is a hook portion and said second portion is a loop portion.

12. Weatherstripping for an opening in a structure having a frame and movable portion that engages said frame to close said opening, said weatherstripping formed from a hook and loop fastener comprising:
a first portion of said hook and loop fastener that is attached to and substantially encompasses said frame around said opening at a location on said frame that engages said moveable portion;
a second portion of said hook and loop fastener that is engaged with said first portion and is not attached to said moveable portion, said second portion having a flexible, compressible backing that forms a flexible, compressible, releasable, weatherproof seal with said moveable portion whenever said moveable portion is in a closed position with said frame, causing said flexible, compressible backing to be compressed against said moveable portion, so that said hook and loop fastener forms said flexible, compressible, releasable, weatherproof seal between said moveable portion and said frame.

13. The weatherstripping of claim 12 further comprising:
a screen attached to said second portion.

14. The weatherstripping of claim 13 wherein said first portion is a loop portion and said second portion is a hook portion.

15. The weatherstripping of claim 12 wherein said first portion is a hook portion and said second portion is a loop portion.

16. The weatherstripping of claim 13 wherein said frame comprises a window frame and said moveable portion comprises a window sash.

17. A method of creating a barrier between a window sash and a window frame using weatherstripping comprising:
providing a hook portion of said weatherstripping that has a backing with a back surface and a front surface, said front surface having hook strands that extend from said front surface of said backing;
providing a loop portion of said weatherstripping that has a flexible and compressible loop backing extending from a first side of said loop portion, and a plurality of loops extending from a second side of said loop backing;
attaching said back surface of said backing of said hook portion of said weatherstripping to said window frame, so that said hook portion substantially surrounds said window frame at a location on said window frame where a sash engages said window frame;
engaging said loop portion of said weatherstripping to said hook portion so that said sash engages and compresses said flexible and compressible loop backing on said first side of said loop portion to provide a weather tight seal between said sash and said window frame and applies pressure to said loop portion to cause said loop portion to securely engage said hook portion.

18. The method of claim 17 further comprising:
forming said hook portion from individual strips attached to said window frame that abut each other;
engaging said loop portion with said hook portion such that said loop portion overlaps said hook portion and holds said hook portion so that gaps are prevented as a result of shrinkage of said hook portion and said loop portion at low temperatures.

19. The method of claim 17 further comprising:
attaching a screen to said loop portion.

20. A method of creating a barrier between a window sash and a window frame using weatherstripping comprising:
providing a loop portion of said weatherstripping that has a backing with a back surface and a front surface, said front surface having loop strands that extend from said front surface of said backing;
providing a hook portion of said weatherstripping that has a flexible and compressible hook backing extending from a first side of said hook portion, and a plurality of hooks extending from a second side of said hook backing;
attaching said back surface of said backing of said loop portion of said weatherstripping to said window frame, so that said loop portion substantially surrounds said window frame at a location on said window frame where a sash engages said window frame;
engaging said hook portion of said weatherstripping to said loop portion so that said sash engages and compresses said flexible and compressible hook backing on said first side of said hook portion to provide a weather tight seal between said sash and said window frame and applies pressure to said hook portion to cause said hook portion to securely engage said loop portion.

21. The method of claim 20 wherein:
forming said loop portion from individual strips attached to said window frame that abut each other;
engaging said hook portion with said loop portion such that said hook portion overlaps said loop portion and holds said loop portion so that gaps are prevented as a result of shrinkage of said loop portion and said hook portion at low temperatures.

22. The method of claim 20 further comprising:
attaching a screen to said hook portion.
